(19) United States
(12) Patent Application Publication
(10) Pub. No.: US 2020/0029057 A1
(43) Pub. Date: Jan. 23, 2020

(54) SYSTEMS AND METHODS FOR CORRECTING COLOR SEPARATION IN FIELD-SEQUENTIAL DISPLAYS

(71) Applicant: QUALCOMM Incorporated, San Diego, CA (US)

(72) Inventors: Samuel Benjamin Holmes, Sterling, MA (US); Robert Vanreenen, San Diego, CA (US)

(21) Appl. No.: 16/037,634

(22) Filed: Jul. 17, 2018

(51) Int. Cl. H04N 9/31; G09G 3/34

(52) U.S. Cl. CPC H04N 9/3114; H04N 9/3117; G09G 2340/06; G09G 2310/0235; G09G 3/3413

(57) ABSTRACT

This disclosure proposes utilizing user movement and virtual object movements to correct a displayed frame in a field-sequential display in a display system. Temporal delay of each color channel is corrected by re-sampling rendered frames before display so each color channel is offset appropriately based on the motion of the rendered content and/or the motion of the user. The correction can be applied during a timewarp rendering pass. A user's physical movement can be corrected using the user's change in pose/position to apply a color channel correction to the entire rendered frame. In-frame content movement can be corrected using the motion of the rendered content to apply focused color channel correction to targeted regions of the rendered frame.

### FIELD

This disclosure relates to the field of displays. In particular, this disclosure relates to techniques for reducing color separation artifacts associated with field-sequential displays (“FSDs”).

### BACKGROUND

Certain display apparatus have been implemented that use an image formation process that generates a combination of separate color subframe images (sometimes referred to as a subfield), which a human mind blends together to form a single image frame. Such image formation processes are particularly, though not exclusively, useful for field-sequential displays, i.e., displays in which the separate color subframes are displayed in sequence, one color at a time. Examples of such displays include micromirror displays and digital shutter based displays. Other displays, such as liquid crystal displays (LCDs) and organic light emitting diode (OLED) displays, which show color subframes simultaneously using separate light modulators or light emitting elements, also may implement such image formation processes.

### SUMMARY

In one embodiment, an apparatus for displaying a video to a user is discussed. The apparatus may include a first field-sequential display (“FSD”) configured to sequentially display a plurality of color channels. The apparatus may include an eye buffer in communication with the first FSD, the eye buffer configured to store a frame of the video. The apparatus may include a processor in communication with the eye buffer, the processor configured to, render an original frame, calculate a user movement compensation based on a FSD color channel delay and user movements based on a difference in a user position determined between a prior frame and the original frame, re-sample the original frame into a corrected frame based on the user movement compensation, and communicate the corrected frame to the eye buffer for display on the first FSD to the user. The processor may be further configured to, calculate a virtual content movement compensation based on the FSD color channel delay and virtual content movements based on a difference in virtual content position determined between the prior frame and the original frame, and further re-sample the original frame into the corrected frame based on the virtual object movement compensation. The apparatus may include a second FSD configured to sequentially display the plurality of color channels, wherein the first and second FSDs are configured to display a 3D video to the user. The first FSD and the second FSD may be at least partially transparent to ambient light. The corrected frame may be re-sampled by a timewarp module executed by the processor. The FSD color channel delay may be determined from a time delay between sequentially displayed color channels. The user movements may be detected with at least one of: HMD motion sensors or motion sensors at a stationary display, and the user movement compensation corrects substantially all of the corrected frame. The user movements may further include movement between the first FSD and the user. The virtual content movement may be computed from a motion of a rendered content and the virtual content movement compensation corrects for the motion of the rendered content within the corrected frame.

In another embodiment, a method for displaying a video to a user is discussed. The method may include rendering an original frame at a processor, wherein the processor is in communication with an eye buffer, wherein the eye buffer is configured to store a frame of the video. The method may include calculating a user movement compensation based on a field-sequential display (“FSD”) color channel delay and user movements based on a difference in a user position determined between a prior frame and the original frame. The method may include re-sampling the original frame into a corrected frame based on the user movement compensation. The method may include communicating the corrected frame to the eye buffer for communication to a first FSD configured to sequentially display a plurality of color channels to the user for display. The method may include calculating a virtual content movement compensation based on the FSD color channel delay and virtual content movements based on a difference in virtual content position determined between the prior frame and the original frame. The method may include further re-sampling the original frame into the corrected frame based on the virtual object movement compensation. The method may include communicating a second corrected frame to a second FSD configured to sequentially display the plurality of color channels, wherein the first and second FSDs are configured to display a 3D video to the user. The first FSD and the second FSD may be at least partially transparent to ambient light. The corrected frame may be re-sampled by a timewarp module executed by the processor. The FSD color channel delay may be determined from a time delay between sequentially displayed color channels. The user movements may be detected with at least one of: HMD motion sensors or motion sensors at a stationary display, and the user movement compensation corrects substantially all of the corrected frame. The user movements may further include movement between the first FSD and the user. The virtual content movement may be computed from a motion of a rendered content and the virtual content movement compensation corrects for the motion of the rendered content within the corrected frame.

In another embodiment, an apparatus for displaying a video to a user is discussed. The apparatus may include a first field-sequential display (“FSD”) means configured to sequentially display a plurality of color channels. The apparatus may include an eye buffer means in communication with the first FSD, the eye buffer configured to store a frame of the video. The apparatus may include a processor means in communication with the eye buffer. The processor means may be configured to render an original frame. The processor means may be configured to calculate a user movement compensation based on a FSD color channel delay and user movements based on a difference in a user position determined between a prior frame and the original frame. The processor means may be configured to re-sample the original frame into a corrected frame based on the user movement compensation. The processor means may be configured to communicate the corrected frame to the eye buffer for display on the first FSD to the user. The processor means may be configured to calculate a virtual content movement compensation based on the FSD color channel delay and virtual content movements based on a difference in virtual content position determined between the prior frame and the original frame. The processor means may be configured to further re-sample the original frame into the corrected frame based on the virtual object movement compensation. The apparatus may include a second FSD means configured to sequentially display the plurality of color channels, wherein the first and second FSDs are configured to display a 3D video to the user. The first FSD means and the second FSD means may be at least partially transparent to ambient light. The corrected frame may be re-sampled by a timewarp module executed by the processor means. The FSD color channel delay may be determined from a time delay between sequentially displayed color channels. The user movements may be detected with at least one of: HMD motion sensors or motion sensors at a stationary display, and the user movement compensation corrects substantially all of the corrected frame. The user movements may further include movement between the first FSD and the user. The virtual content movement may be computed from a motion of a rendered content and the virtual content movement compensation corrects for the motion of the rendered content within the corrected frame.

In another embodiment, a non-transitory computer-readable storage medium having stored thereon instructions that, when executed, cause a processor to execute a method for displaying a video to a user is discussed. The method may include rendering an original frame at a processor, wherein the processor is in communication with an eye buffer, wherein the eye buffer is configured to store a frame of the video. The method may include calculating a user movement compensation based on a field-sequential display (“FSD”) color channel delay and user movements based on a difference in a user position determined between a prior frame and the original frame. The method may include re-sampling the original frame into a corrected frame based on the user movement compensation. The method may include communicating the corrected frame to the eye buffer for communication to a first FSD configured to sequentially display a plurality of color channels to the user for display. The method may include calculating a virtual content movement compensation based on the FSD color channel delay and virtual content movements based on a difference in virtual content position determined between the prior frame and the original frame. The method may include further re-sampling the original frame into the corrected frame based on the virtual object movement compensation. The method may include communicating a second corrected frame to a second FSD configured to sequentially display the plurality of color channels, wherein the first and second FSDs are configured to display a 3D video to the user. The first FSD and the second FSD may be at least partially transparent to ambient light. The corrected frame may be re-sampled by a timewarp module executed by the processor. The FSD color channel delay may be determined from a time delay between sequentially displayed color channels. The user movements may be detected with at least one of: HMD motion sensors or motion sensors at a stationary display, and the user movement compensation corrects substantially all of the corrected frame. The user movements may further include movement between the first FSD and the user. The virtual content movement may be computed from a motion of a rendered content and the virtual content movement compensation corrects for the motion of the rendered content within the corrected frame.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an example graphics pipeline of a display system.

FIG. 2A illustrates an example color separation artifact in field-sequential displays.

FIG. 2B illustrates an example in-frame content movement.

FIG. 2C illustrates examples of user motion.

FIGS. 3A & 3B illustrate a block/flow diagram of an example dual-display VR/AR system.

FIG. 4 illustrates a block/flow diagram of an example single-display VR/AR system.

FIG. 5 is a block diagram of an example portable computing device implementing the display systems discussed above.

FIG. 6 illustrates a process for generated corrected frames for a field-sequential display.

FIG. 7 illustrates an example output eliminating color separation artifacts in field-sequential displays.

### DETAILED DESCRIPTION

Field-sequential displays sequentially illuminate color channels to display a frame or image to a user (as opposed to simultaneously). For example, a red channel may illuminate first, followed by a blue channel, followed by a green channel. The cycle continues with the red channel. This sequential update may introduce artifacts such as a color fringe when displaying objects as the delay in displaying the different color channels may cause visible separation between the color channels. For example, an object moving across the display will need to have each subsequent color channel shifted in the direction of the object's movement. This can be further accentuated in VR and AR displays as even stationary virtual objects will move in response to user head movement.

Such artifacts can be reduced or eliminated by utilizing user movement and virtual object movements to correct the image before display. Temporal delay of each color channel is corrected by re-sampling rendered frames before display so each color channel is offset appropriately based on the motion of the rendered content and the motion of the user. The correction can be applied during a timewarp rendering pass.

Two types of motions can be compensated for. First, a user's physical movement (for example, head movement), is corrected by using the user's change in pose or position to apply a color channel correction to the entire rendered frame.

Second, in-frame content movement is corrected by using the motion of the rendered content to apply color channel correction to targeted regions of the rendered frame. Motion data about rendered content may be block-based (such as a the field of motion vectors produced by feeding a sequence of rendered frames through a video encoder) or pixel-based (such as the velocity map produced by tracking object motion in a rendering engine).

Existing virtual reality (VR) and augmented reality (AR) computer systems employ a sophisticated graphics pipeline or rendering pipeline. The graphics pipeline generally comprises the hardware and/or software components for performing the sequence of steps used to create a two-dimensional raster representation of a three-dimensional scene. Once a three-dimensional model has been created by, for example, a video game or other VR or AR application, the graphics pipeline performs the process of turning the three-dimensional model into the two-dimensional raster representation scene for display to the user. The two-dimensional raster representation includes a multiview rendering comprising a separate rendering for the left and right eyes.

In many VR/AR systems, the graphics pipeline comprises a graphics processing unit (GPU), a double data rate (DDR) memory, and a display processor. The GPU generates the left and right eye views. Each view is separately compressed before storing in the DDR memory for subsequent pipeline processing (e.g., time warping, display processing, etc.). During further processing by the GPU or the display processor, each view is retrieved from the DDR memory, separately decompressed, and then processed. Where timewarping is performed to improve motion-to-photon latency, the separate timewarped left and right views are again compressed and stored in the DDR memory for subsequent decompression and processing by the display processor.

Some contemporary LCD displays implement field-sequential displays by using a plurality of colors of LED backlight. By cycling the backlights, such display systems have several advantages such as brighter colors, darker blacks, and lower cost.

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” “engine”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

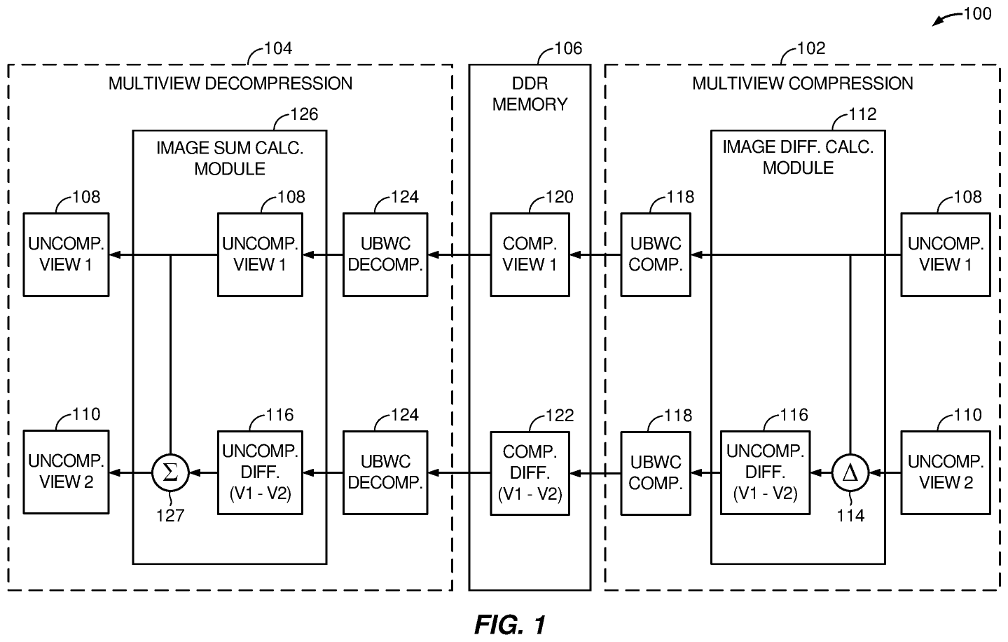

FIG. 1 is a block diagram of an example graphics pipeline of a display system. The display system 100 may be any system configured to display visual content to a user. In one example, the display system 100 may be a stand-alone or a hybrid head-mounted display for displaying virtual reality (“VR”) or augmented reality (“AR”) content to a user. In such systems, the user's head and the display move together in tandem. Alternatively, the display system 100 may allow the user to move relative to the display. In one example, this may be a user viewing content on a mobile device. In another example, this may be a user viewing content on a stationary display such as a television or other large display screen, and the system compensates for user movements if necessary. In these examples, user movement relative to the display may be tracked with various sensors providing image and/or depth data. In another example, the display may be moving relative to real-world objects (for example, in an augmented reality embodiment) such that there are display movements, user head movements relative to the display, and/or content movements.

It should be appreciated that the display system 100 may be implemented in various types of VR and/or AR systems. For example, the system 100 may be incorporated in integrated VR and/or AR systems, such as, integrated headsets, goggles, eyewear, projection systems, etc. In other embodiments, the system 100 may be incorporated in personal computers, laptop computers, gaming consoles, or portable computing devices, such as, smart phones, tablet computers, portable gaming consoles, etc., which may be integrated with a head mount kit or a head mount display (HMD) that is worn by a user. In this regard, it should be appreciated that one or more of components in the system 100 may be integrated into the HMD while others may be provided by an external processing system (e.g., a portable computing device) or external display (e.g., a computer display, a projection display, etc.).

As illustrated in FIG. 1, the system 100 comprises a double data rate (DDR) memory 106 electrically coupled to one or more processors in the graphics pipeline (e.g., a graphics processing unit (GPU), a display processor, etc.). As illustrated in FIG. 1, the DDR memory 106 does not store separate compressed versions of each view in the multiview rendering. For example, instead of storing both a compressed version of a right eye view and a compressed version of a left eye, the system 100 provides memory bandwidth and power savings by taking advantage of any similarity between the right eye view and the left eye view.

The system 100 comprises a multiview compression module 102 and a multiview decompression module 104 for performing the compression and decompression, respectively. As described below in more detail, the various components in the graphics pipeline (e.g., GPU 302, display processor 304, etc.) may implement one or both of the compression and decompression modules 102 and 104 depending on the nature of the graphics processing phase (e.g., eye buffer rendering phase, timewarp phase, display phase, etc.) and the type of display (e.g., single display versus dual display).

In the embodiment of FIG. 1, the multiview compression module 102 comprises an image differential calculation module 112 and one or more compression module(s), such as, for example, universal bandwidth compression (UBWC) compression module 118. In the embodiment illustrated in FIG. 1, compression and/or decompression may be performed via universal bandwidth compression/decompression (UBWC). UBWC compresses graphical buffers, such as GPU, video, and/or camera buffers. UBWC may work on a per-tile basis with a UBWC tile comprising a predetermined number of pixels (e.g., 4, 8, or more pixels). It should be appreciated that universal bandwidth compression may increase the effective bandwidth of the system, reduce the power consumption for the memory subsystem, (e.g., DDR, memory controller, data path, etc.), and reduce the power consumption of IP cores by making them run more efficiently and at lower voltage levels.

Referring to FIG. 1, the image differential calculation module 112 receives as inputs a first image and a second image. The first image comprises an uncompressed version of a first view 108 (e.g., one of a left eye view and a right eye view), and the second image comprises an uncompressed version of a second view 110 (e.g., the other of the left eye view and the right eye view). The first view 108 is compressed via UBWC compression module 118, which generates a compressed first view 120. The compressed first view 120 is stored in DDR memory 106. Rather than compressing the second view 110, the image differential calculation module 112 compares the second view 110 to the first view 108 to determine any distortions or differences between the two images. In an embodiment, the first view 108 and the second view 110 are provided to a delta image calculation component 114 to determine the differing data between the two images. In an embodiment, the delta image calculation component 114 may comprise a simple subtraction algorithm with the resulting output being another image that is a result of a pixel-by-pixel subtraction. For example, if pixel [x, y, Red] of view 1 has a value of pf 250 and pixel [x, y, Red] of view 2 has a value of pf 249, the resulting pixel [x, y, Red] for the output image will have a value of 1 equal to the difference between the values. It should be appreciated that alternative embodiments may employ other desirable linear operations for determining the difference between the two images. Referring to FIG. 1, the delta image calculation component 114 outputs an uncompressed difference (V1−V2) 116 between the first view 108 and the second view 110. The uncompressed difference 116 is provided to UBWC compression module 118, which generates a compressed version 122 of the difference (V1−V2)116. The compressed version 122 of the difference (V1−V2)116 is stored in DDR memory 106.

It should be appreciated that, because much of the image data between the first and second views 108 and 110 will be similar, the delta or difference determined by the delta image calculation component 114 may comprise a relatively large percentage of zero values. Therefore, when the uncompressed difference 116 is compressed by UBWC compression module 118, a relatively high compression ratio may be achieved, which results in memory bandwidth savings during the transfer to DDR memory 106.

During a subsequent stage in the graphics pipeline, the multiview decompression module 104 may retrieve the compressed version 122 of the difference (V1−V2)116 and the compressed first view 120. Again with the relatively high compression ratio associated with the difference (V1−V2)116, the system 100 again results in memory bandwidth savings during the retrieval from DDR memory 106. The compressed difference 122 and the compressed first view 120 are input to a UBWC decompression module 124, which generates the original uncompressed first view 108 and the original uncompressed difference 116 between the first and second views 108 and 110.

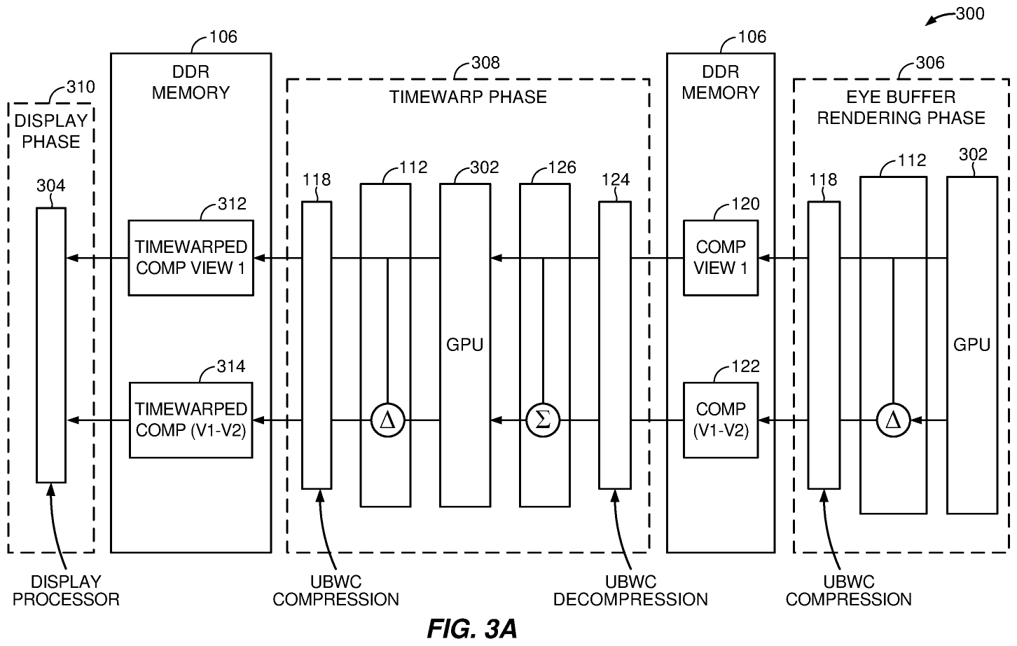

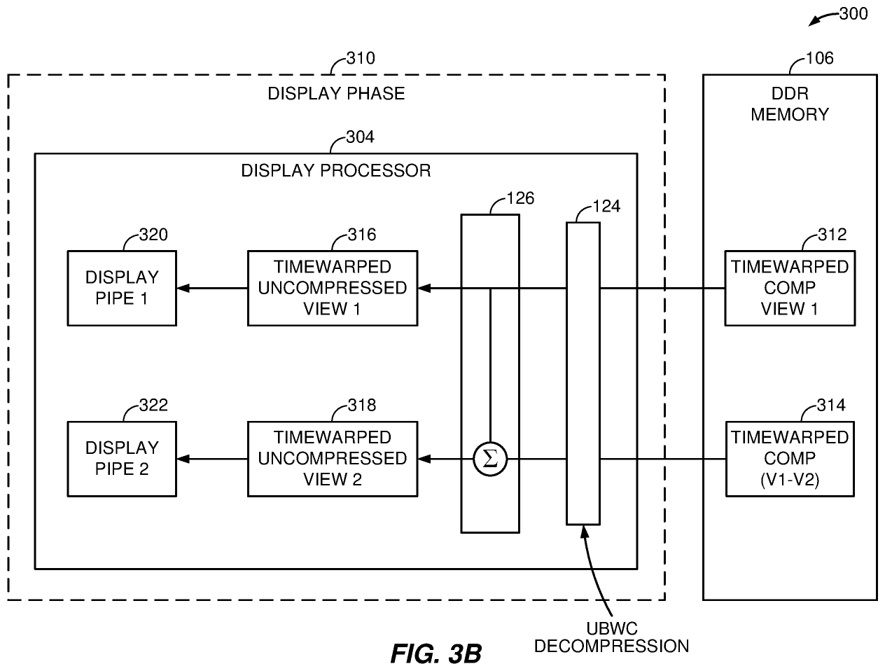

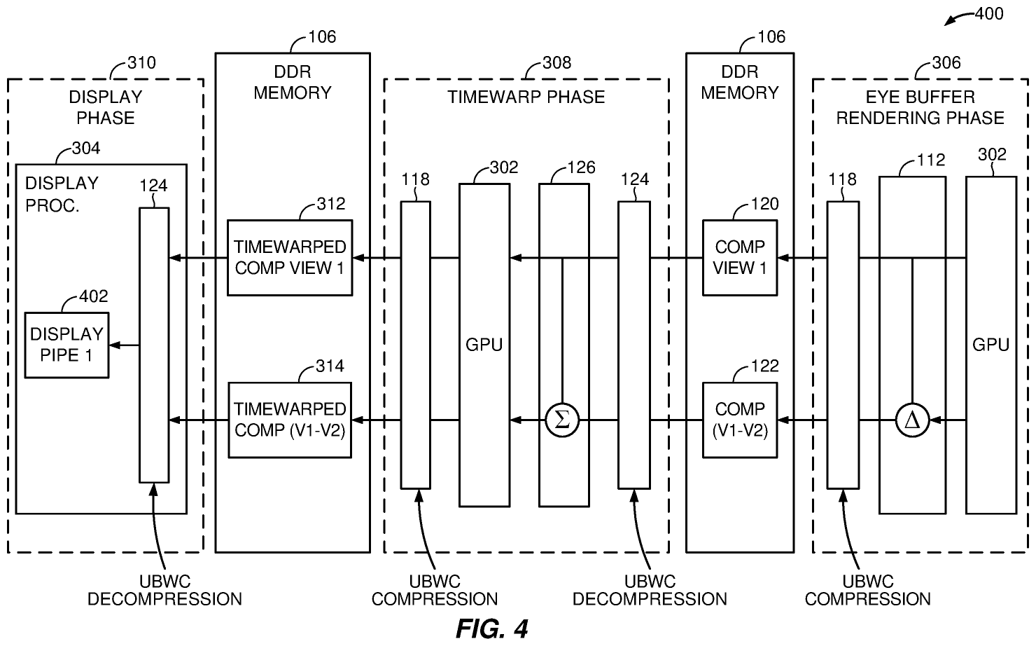

As further illustrated in FIG. 1, the multiview decompression module 104 may further comprise an image calculation summation module 126 in communication with UBWC decompression module(s) 124. The image calculation summation module 126 receives the original first view 108 and the original difference 116 from UBWC decompression module(s) 124, and generates the original second view 110 by comparing the difference 116 to the first view 108. It should be appreciated that the image summation calculation module 126 comprises the inverse of the image difference calculation operation performed by the module 112. For example, where the image difference calculation operation comprises a subtraction operation, as described above, the image summation calculation module 126 may perform an simple addition operation. As described below in more detail, it should be appreciated that the first and second views 108 and 110 may be further processed by the graphics pipeline, which may involve display to a single display VR device (FIG. 4) or a dual display VR device (FIGS. 3A and 3B) and/or further processing by a GPU 302 in a timewarp phase 308 (FIGS. 3A, 3B, and 4). Subsequent processing may involve further compression and decompression sequences using image differential calculation module 112 and image summation calculation module 126 with corresponding storage in DDR memory 106, which will result in further savings of memory bandwidth.

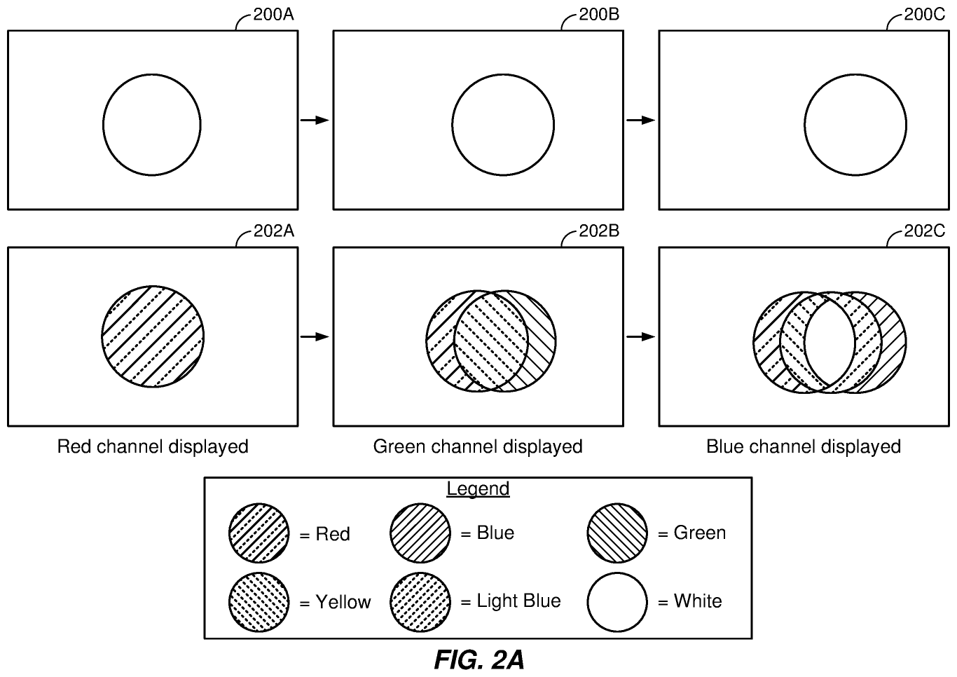

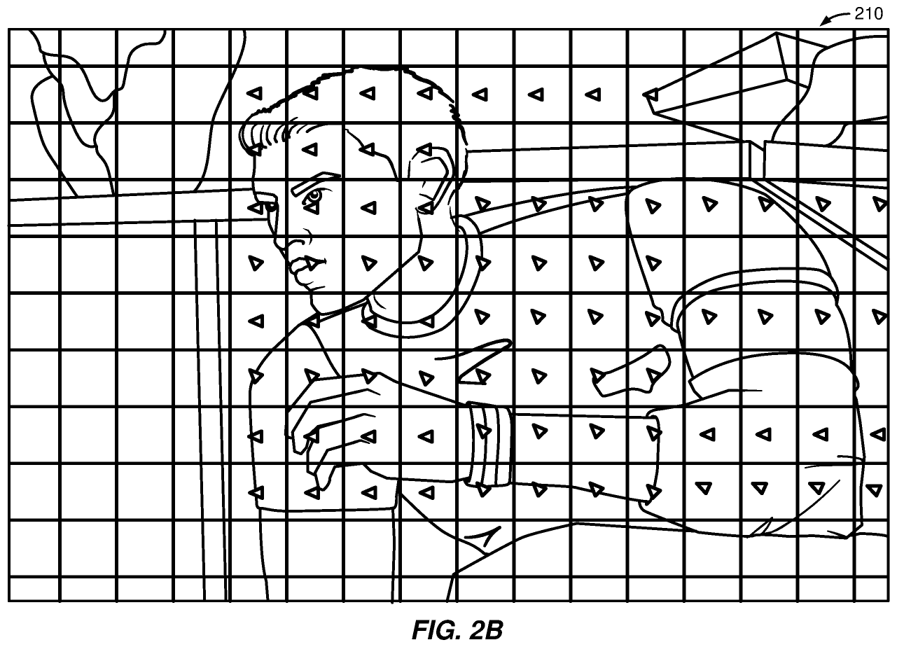

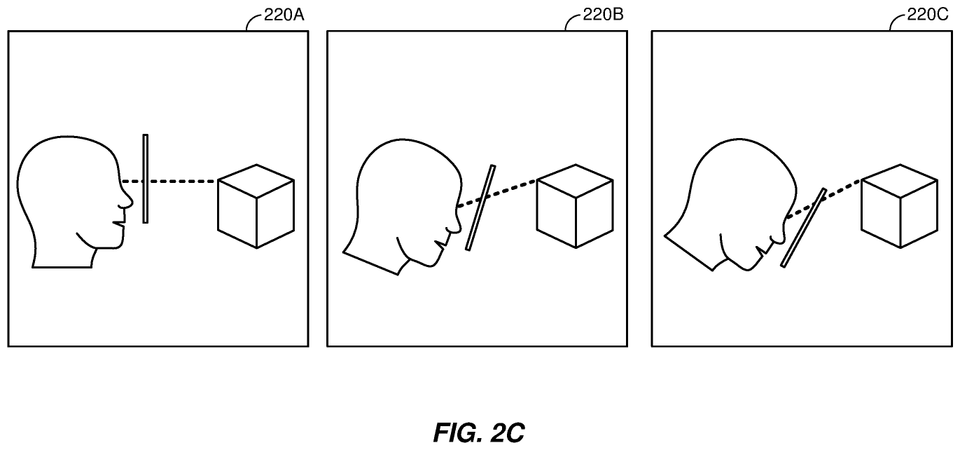

FIG. 2A illustrates an example color separation artifact in field-sequential displays. A sequence of images 200A, 200B, and 200C illustrates an example intended image sequence of a white circle moving rightward on the display. However, what is actually displayed is illustrated in a sequence of images 202A, 202B, 202C. As discussed above, field-sequence displays sequentially illuminate one color channel over time. To display a white object, a red, green, and blue channel must all illuminate in the same space. Here, it can be seen that the red channel is first displayed in image 202A. As the circle is moving rightward, the green channel is displayed in image 202B to the right of the displayed red circle. Finally, the blue channel is displayed in image 202C even further to the right. This results in visual artifacts, such as “color drifting” or “color fringing” when displaying moving objects, illustrated in image 202C. In VR/AR displays, displayed objects may move due to content animation or user motion, discussed below.

FIG. 2B illustrates an example in-frame content movement. Content animation may be a source of movement of virtual objects in an VR/AR environment. An image 210 may be divided into blocks as illustrated. Each block may be associated with a motion estimation for content motion compared with a subsequent image. Motion estimation may include both direction and magnitude, as illustrated by arrows within blocks where content will move. It can be seen that the character illustrated in image 210 is moving from right to left. It will be appreciated that blocks including background images may remain substantially stationary.

FIG. 2C illustrates examples of user motion. User motion may be a source of movement of virtual objects in an VR/AR environment. Image 220A illustrates a first frame, where a user with an VR/AR headset display is looking straight at a virtual object. Image 220B illustrates a second frame, where the user is tilting his head (and therefore, the VR/AR headset display) downward. Image 220C illustrates a third frame, where the user is further tilting his head and VR/AR headset downward. It will be appreciated that the virtual object must be displayed higher on the VR/AR display in 220B to maintain its relative fixed position in the virtual environment. The virtual object must be displayed higher still in image 220C. User movement will require motion from all displayed virtual objects that are stationary in the virtual environment.

As discussed above, in non-HMD embodiments, user motion relative to the display can be detected and utilized in content compensation as well.

FIGS. 3A & 3B illustrate a block/flow diagram of an example dual-display VR/AR system. In this embodiment, the graphics pipeline comprises an eye buffer rendering phase 306, a timewarp phase 308, and a display phase 310. The eye buffer rendering phase 306 and the timewarp phase 308 are executed by a GPU 302. The display phase 310 is executed by a display processor 304.

As illustrated in FIG. 3B, the eye buffer rendering phase 302 involves a first instance of the multiview compression module 102 and UBWC compression 118 described above in connection with system 100 (FIG. 1). The result of the eye buffer rendering phase 302 is the storage in DDR memory 106 of the compressed first view 120 and the compressed difference 122 between the first and second uncompressed views 108 and 110.

A VR graphics pipeline may reduce motion-to-photon latency using a graphics rendering technique referred to as “timewarp”, “reprojection”, or “rerendering” (collectively referred to as “timewarp”). Timewarp involves warping the rendered image before sending it to the display to correct for the user's movement that occurred after the rendering. Timewarp may reduce latency and increase or maintain frame rate (i.e., the number of frames display per second (fps)). This process takes an already rendered image, modifies it with the predicted positional information based on the collected positional information obtained from sensors (e.g., sensor(s) housed in a HMD), and then displays the modified image on the VR display.

Without timewarp, the system would capture the data about the position of the user, render the image based on this positional data, and then display the image when the next scene is due. For example, in a 60 frames per second (fps) VR application, a new scene may be displayed once every 16.7 ms. Each image that is displayed is based on the positional data that was obtained approximately 16.7 ms ago. With timewarp, however, the VR system captures the positional data, renders the image based on the positional data, and before displaying the image the VR system captures updated positional data. Using the updated positional data, the rendered image is modified with appropriate algorithms to fit the latest position of the user, and then displayed to the user. In this manner, the modified image is more recent and more accurately reflects the position of the user at the time of the display than the image that was initially rendered.

As will be appreciated by those skilled in the art, Timewarp/Time warping (also known as Reprojection) is a technique in VR that warps the rendered image before sending it to the display to correct for head movement occurred after the rendering. Timewarp can reduce latency and increase or maintain frame rate. Additionally, it can reduce judder caused missed frames (when frames take too long to render). This process takes the already rendered image, modify it with freshly collected positional information (for example, from a HMD's sensors) before displaying the modified rendered image. Utilizing depth maps (Z Buffers) already present in the engine, Timewarp requires very little computation.

Asynchronous Timewarp or ATW is when timewarp occurs on another thread in parallel (asynchronously) with rendering. Before every vsync, the ATW thread generates a new timewarped frame from the latest frame completed by the rendering thread. ATW fills in the missed frames and reduces judder.

Without Timewarp, a HMD would capture user head position data, render the image based on this data, then display the image when the next scene is due to be on screen. In a 60 fps display system, a new image is displayed once every 16.7 milliseconds. With this process, each displayed image is based on head-tracking data from almost 17 milliseconds ago.

With Timewarp, the user head position data is captured again before displaying the rendered images. Using this information, the rendered image is modified with a mathematical calculation to fit the latest data. The modified image is displayed on screen. The resulting image is more recent and more accurately reflect the user head position at the time of display. Timewarp only works in very short distances and time intervals or the resulting image will look unrealistic or out of place.

Timewarp allows display system engines to increase or maintain frame rate when they are otherwise unable to do. It does this by artificially filling in dropped frames. For example, in a display system engine limited to 50 frames per second, a new frame is displayed once every 20 milliseconds. To increase the frame rate to 60, a new frame needs to be displayed once every 16.7 milliseconds. To increase the fps through timewarp, the last completely rendered frame is updated with the latest user head position data. The modified frame is displayed to meet the desired fps target.

As illustrated in FIG. 3A, the timewarp phase 308 may involve a first instance of the multiview decompression module 104 and UBWC decompression. In the decompression stage of the timewarp phase 308, the GPU 302 retrieves the compressed view 120 and the compressed difference 122 from the DDR memory 106 to determine the original first and second views. The GPU 302 may receive updated positional data, as described above, and modify the first and second views to fit the latest position of the user. The modified first and second views may be further processed via another instance of the multiview compression module 352 and UBWC compression. The result of the timewarp phase 352 is the storage in DDR memory 106 of a timewarped compressed first view 312, and a timewarped compressed difference between the modified first and second views. The use of multiview compression module 352 and the multiview decompression module 104 during the timewarp phase 308 may result in additional GPU-to-DDR memory bandwidth savings.

The timewarp phase 308 may be further configured to correct the first and second views for color channel separation, based on calculations further discussed herein. For example, the color channel separation correction calculations can account for both headset movement and virtual object movement.

The timewarp phase 308 may be followed by the display phase 310, which is executed by the display processor 304. As illustrated in FIG. 3B, the display phase 310 may involve a further instance of the multiview decompression module 104 and UBWC decompression. The display processor 304 retrieves the timewarped compressed view 312 and the timewarped compressed difference 314 from the DDR memory 106. View 312 and difference 314 are decompressed by the UBWC module, and then used to determine the original timewarped, uncompressed views 316 and 318. The view 316 may be provided to a first display pipe 320 for a first display device, and the view 318 may be provided to a second display pipe 322 for the second display device. The use of multiview decompression module 104 during the display phase 310 may result in display-processor-to-DDR memory bandwidth saving.

In an exemplary embodiment, the display hardware may read the two views synchronously. For example, in the case of a dual-display VR system, the two views may be synchronously read, which may allow the timewarp to write out a frame buffer with multi-view compression enabled. It should be appreciated that, because the reads are synchronous from DDR memory 106, both the view 1 pixel values and the difference view pixel values may exist on the same buffer on the display device, and view 2 may be calculated on-chip without a need to go to DDR memory 106. To illustrate these advantages, it should be appreciated that in existing solutions in which the two views are ready by the display hardware in serial (e.g., single display phones), the timewarp cannot write the frame buffer with multi-view compression. This is because in order to calculate view 2, both the difference view and the view 1 pixel values are be read from DDR memory, which results into 2× read per pixel for view 2, which defeats the benefit and purpose of multi-view compression, which is to reduce memory traffic BW.

FIG. 4 illustrates a block/flow diagram of an example single-display VR/AR system. As mentioned above, FIG. 3 illustrates an embodiment in which the display read is synchronous between the two views. As a result, the timewarp write and display read operation benefit from multi-view compression. FIG. 4 shows a case where the display read is not synchronous between the two views. It should be appreciated that in a single-display embodiment because the display read is not synchronous, the view 1 and the difference view may both be needed to extract view 2, which may yield 2 pixel read from DDR memory 106 per one pixel in view 2. By contrast, in the synchronous mode illustrated in FIG. 3, the view 1 may be already available in the chip.

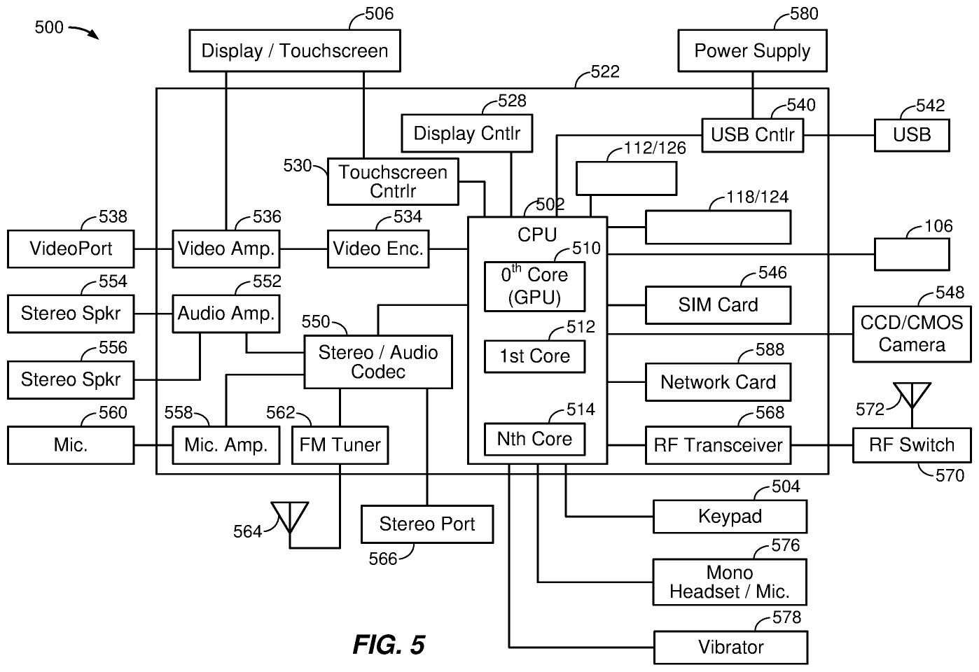

FIG. 5 is a block diagram of an example portable computing device implementing the display systems discussed above. As mentioned above, the system 100 may be incorporated into any desirable computing system. FIG. 5 illustrates an embodiment in which one or more components of the system 100 are incorporated in an exemplary portable computing device (PCD) 500. PCD 500 may comprise a smartphone, a tablet computer, a wearable device (e.g., HMD 200). It will be readily appreciated that certain components of the system 100 are included on the SoC 522 (e.g., multiview compression module 352 and multiview decompression module 104) while other components (e.g., the DDR memory 106) are external components coupled to the SoC 522. The SoC 522 may include a multicore CPU 502. The multicore CPU 502 may include a zeroth core 510, a first core 512, and an Nth core 514. One or more of the cores, for example the zeroth core 510, may comprise, a graphics processing unit (GPU). The remaining cores may comprise the CPU, or other processing units.

A display controller 528 and a touch screen controller 530 may be coupled to the CPU 502. In turn, the touch screen display 505 external to the on-chip system 522 may be coupled to the display controller 528 and the touch screen controller 530.

FIG. 5 further shows that a video encoder 534, e.g., a phase alternating line (PAL) encoder, a sequential color a memoire (SECAM) encoder, or a national television system(s) committee (NTSC) encoder, is coupled to the multicore CPU 502. Further, a video amplifier 536 is coupled to the video encoder 534 and the touch screen display 506. Also, a video port 538 is coupled to the video amplifier 536. As shown in FIG. 5, a universal serial bus (USB) controller 540 is coupled to the multicore CPU 502. Also, a USB port 542 is coupled to the USB controller 540. Memory 104 and a subscriber identity module (SIM) card 546 may also be coupled to the multicore CPU 502.

Further, as shown in FIG. 5, a digital camera 548 may be coupled to the multicore CPU 502. In an exemplary aspect, the digital camera 548 is a charge-coupled device (CCD) camera or a complementary metal-oxide semiconductor (CMOS) camera.

As further illustrated in FIG. 5, a stereo audio coder-decoder (CODEC) 550 may be coupled to the multicore CPU 502. Moreover, an audio amplifier 552 may be coupled to the stereo audio CODEC 550. In an exemplary aspect, a first stereo speaker 554 and a second stereo speaker 556 are coupled to the audio amplifier 552. FIG. 5 shows that a microphone amplifier 558 may be also coupled to the stereo audio CODEC 550. Additionally, a microphone 560 may be coupled to the microphone amplifier 558. In a particular aspect, a frequency modulation (FM) radio tuner 562 may be coupled to the stereo audio CODEC 550. Also, an FM antenna 564 is coupled to the FM radio tuner 562. Further, stereo headphones 566 may be coupled to the stereo audio CODEC 550.

FIG. 5 further illustrates that a radio frequency (RF) transceiver 568 may be coupled to the multicore CPU 502. An RF switch 570 may be coupled to the RF transceiver 568 and an RF antenna 572. A keypad 204 may be coupled to the multicore CPU 502. Also, a mono headset with a microphone 576 may be coupled to the multicore CPU 502. Further, a vibrator device 578 may be coupled to the multicore CPU 502.

FIG. 5 also shows that a power supply 580 may be coupled to the on-chip system 522. In a particular aspect, the power supply 580 is a direct current (DC) power supply that provides power to the various components of the PCD 500 that require power. Further, in a particular aspect, the power supply is a rechargeable DC battery or a DC power supply that is derived from an alternating current (AC) to DC transformer that is connected to an AC power source.

FIG. 5 further indicates that the PCD 500 may also include a network card 588 that may be used to access a data network, e.g., a local area network, a personal area network, or any other network. The network card 588 may be a Bluetooth network card, a WiFi network card, a personal area network (PAN) card, a personal area network ultra-low-power technology (PeANUT) network card, a television/cable/satellite tuner, or any other network card well known in the art. Further, the network card 588 may be incorporated into a chip, i.e., the network card 588 may be a full solution in a chip, and may not be a separate network card 588.

As depicted in FIG. 5, the touch screen display 506, the video port 538, the USB port 542, the camera 548, the first stereo speaker 554, the second stereo speaker 556, the microphone 560, the FM antenna 564, the stereo headphones 566, the RF switch 570, the RF antenna 572, the keypad 574, the mono headset 576, the vibrator 578, and the power supply 580 may be external to the on-chip system 522.

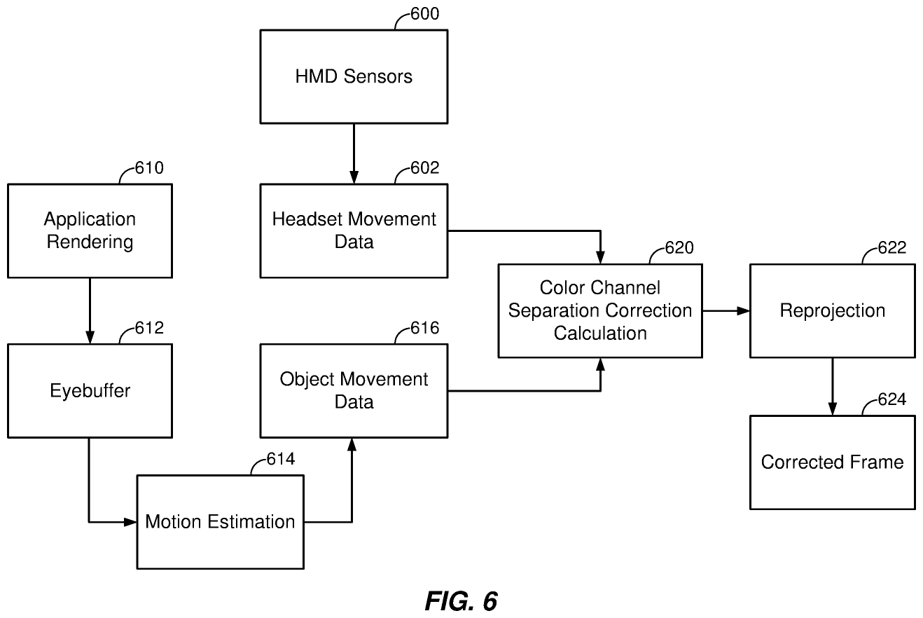

FIG. 6 illustrates a process for generated corrected frames for a field-sequential display. It will be appreciated the process can be executed on both displays of a 3-D video system. In some example embodiments, the discussed process may apply to HMD devices where each of the left and right eye views are composed of multiple individual displays working in unison.

In 600, HMD sensors may collect user movement information. For example, HMD sensors may include motion, gyroscopic and accelerometer sensors to determine user head and body position. User movement information can also be collected by a sensor system external to the HMD, such as optical infrared red (“IW”) tracking systems working via computer vison recognition of IR tracking elements. Such systems may include various cameras and/or depth sensors. In another example, the sensor system may rely on timing of IR laser light detected at specific locations on the HMD. Other example sensor systems may include magnetic field-based position and orientation tracking systems. Such systems may also be used in non-HMD devices as discussed above.

In 602, a headset movement data may be calculated from the user movement collected above. The user movement can be used by a processor to calculate a user movement compensation, as discussed below. For example, if the user is turning his head from right-to-left, subsequent color channels need to be corrected for the right-to-left movement to ensure no viewing artifacts resulting from displaying the color channels sequentially.

In 610, an application may render a video for display to the user or viewer. The video may include a plurality of frames to be played back sequentially and comprise a 3-D video. The application may sequentially render a plurality of original frames for the eye buffer below. In another embodiment, the video may be virtual content to be overlaid on a visible outside environment through transparent displays, for example, in an AR system. In this example, the display may be at least partially transparent to ambient light.

In one embodiment, the original frame may be rendered with a lenses distortion correction warping operation to account for warping by lenses used in the display.

In 612, each frame of the video may be communicated to an eye buffer. For example, the eye buffer can be computer-readable memory, as illustrated above, for storing data that comprise the frame.

In 614, a motion estimation can be computed. For example, a motion vector array, further discussed below, may describe the motion of virtual objects within the video across the eye buffer. Motion vector data may be block-based, as is typically produced by video encoders, per-pixel, or in other formats. It will be appreciated by those skilled in the art that block-based motion estimation may also be produced by computer vision systems performing feature tracking, separate from video encoding motion estimation that was originally intended for compression purposes.

In 616, a processor can compute a virtual content movement compensation necessary to correct for virtual content movements within the video. If a virtual object is moving within the video, displaying it correctly will require each subsequent color channel to be corrected before display.

In contrast to user movement compensation calculated in 602, which applies to all or substantially all of the video visible to the user, the virtual content movement compensation will likely be targeted towards visible moving virtual objects.

In 620, the processor can computer a color channel separation correction offset utilizing the user movement compensation and the virtual content movement compensation. There is a color channel display between sequentially displaying each color channel in a field-sequential display. To compensate for the color channel delay, each subsequent frame should be offset by the compensations computed above. A magnitude of each compensation may, for example, be dependent on how fast the user or virtual content is moving within the video. A direction of each compensation may, for example, offset the color drift artifact discussed above. Example pseudo-code for computing the compensations is given below.

In 622, the original frame may be re-sampled or re-rendered into a corrected frame with the offsets computed above. In one embodiment, the re-sampling can be executed by a timewarp module executed by the processor. It will be appreciated that reprojection 622 may also receive as input eyebuffer 612 to execute the warping process discussed above.

In 624, the corrected frame can be communicated to a frame buffer, for display to the viewer or user. It will be appreciated by those of ordinary skill in the art that this process can be applied to two separate frames, for example, in a 3-D video with a left view and a right view.

In one example, the correction discussed herein can be applied via pseudo-code below:

```
// For this example, given motion vector data in MotionVectorArray[X][Y] describing
the motion of virtual objects across the eyebuffer. Motion vector data could be block-
based, as is typically produced by video encoders, or it could be per-pixel or in other
formats.
ivec2 ArrayLocation = ivec2((FragmentPosition.X * MotionVectorArrayWidth) /
EyebufferWidth,
        (FragmentPosition.Y * MotionVectorArrayHeight) /
EyebufferHeight);
vec2 EyebufferOffset = MotionVectorArray[ArrayLocation.X][ArrayLocation.Y];
// VR/AR/XR displays typically include a non-linear lens distortion correction warping
operation. In order to apply an accurate color separation correction based on linear user
movement, the linear offset needs to be transformed back to the pre-lens offset on the
display.
// Given a function InvertLensDistortion(x) which applies the inverse of the lens
distortion correction to a fragment position.
// Given a HeadMovement vector indicating the user's movement for the duration of this
frame.
vec2 DisplayOffset = InvertLensDistortion(FragmentPosition − HeadMovement) −
InvertLensDistortion(FragmentPosition);
// The final offset is inverted as eyebuffer and display offsets are in the direction of
movement, but the correcting offset needs to be in the opposite direction to the
movement.
vec2 FinalOffset = −1 * (EyebufferOffset + DisplayOffset);
// Given time offsets for each channel, defined such that 0 offset is no time differential
between when a color channel is illuminated by the display and the total time of
illumination for all channels.
// For example, on a 60hz display where the color channels are illuminated in R-G-B
order with each channel utilizing 1/4th of the total frame time (with a 1/4 frame vblank
period), one set of offset values could be:
// TotalFrameDuration = 16.667 milliseconds
// RedIlluminationTimeOffset = 0 * (TotalFrameDuration / 4) = 0 milliseconds
// GreenIlluminationTimeOffset = 1 * (TotalFrameDuration / 4) = 4.16675
milliseconds
// BlueIlluminationTimeOffset = 2 * (TotalFrameDuration / 4) = 8.33350
milliseconds
// This example shifts the green and blue channels back so all channels align with the
natural illumination time of the red channel, which undergoes no offset/correction.
ivec2 RedOffset = ivec2(FinalOffset * (RedIlluminationTimeOffset /
TotalFrameDuration));
ivec2 GreenOffset = ivec2(FinalOffset * (GreenIlluminationTimeOffset /
TotalFrameDuration));
ivec2 BlueOffset = ivec2(FinalOffset * (BlueIlluminationTimeOffset /
TotalFrameDuration));
// Sample red, green, and blue from eyebuffer texture based on color sample location
offsets calculated above
fragcolor = vec3(EyebufferTexture(FragmentPosition + RedOffset).R,
      EyebufferTexture(FragmentPosition + GreenOffset).G,
      EyebufferTexture(FragmentPosition + BlueOffset).B);
```

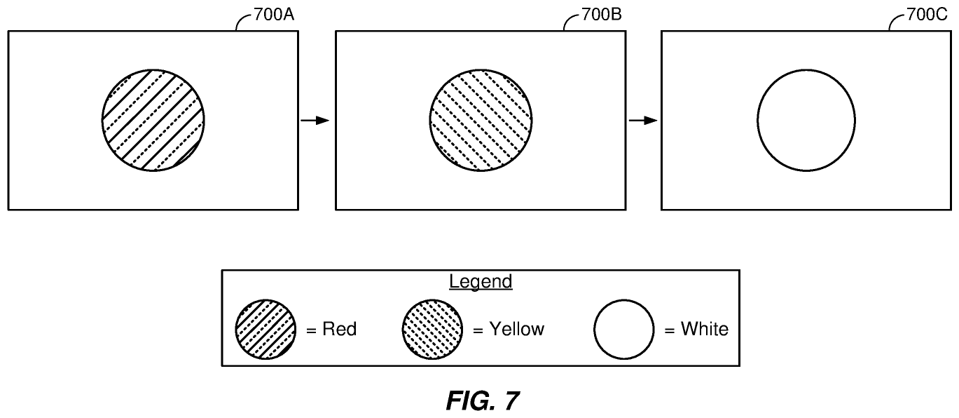

FIG. 7 illustrates an example output eliminating color separation artifacts in field-sequential displays. A sequence of images 700A, 700B, and 700C illustrates an example corrected color sequence. A red channel is displayed in image 700A, producing an output of a red circle. A green channel is displayed in image 700B, but corrected for virtual object motion and an illumination delay between the green and red channels, thus producing an output of a yellow circle. Finally, the blue channel is displayed in image 700C, further corrected for virtual object motion and an illumination delay between the green and blue channels, thus producing an output of a white circle.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. For example, it should be appreciated that the multi-view compression/decompression methods described above may be applied to various types of multimedia cores and applications, such as, for example, a camera supporting stereo input, a video decode supporting stereo video decode, and an encoder supporting stereo camera encoding. Therefore, although selected aspects have been illustrated and described in detail, it will be understood that various substitutions and alterations may be made therein without departing from the spirit and scope of the present invention, as defined by the following claims.

1. An apparatus for displaying a video to a user, comprising:
a first field-sequential display (“FSD”) configured to sequentially display a plurality of color channels;
an eye buffer in communication with the first FSD, the eye buffer configured to store a frame of the video; and
a processor in communication with the eye buffer, the processor configured to,
render an original frame,
calculate a user movement compensation based on a FSD color channel delay and user movements based on a difference in a user position determined between a prior frame and the original frame,
calculate a virtual content movement compensation based on the FSD color channel delay and virtual content movements, the virtual content movements based on a first difference in virtual content position of a first block and a second difference in virtual content position of a second block, the first and second differences determined between the prior frame and the original frame,
re-sample the original frame into a corrected frame based on the user movement compensation and the virtual content movement compensation, and
communicate the corrected frame to the eye buffer for display on the first FSD to the user.

2. (canceled)

3. The apparatus of claim 1, further comprising:
a second FSD configured to sequentially display the plurality of color channels, wherein the first and second FSDs are configured to display a 3D video to the user.

4. The apparatus of claim 3, wherein the first FSD and the second FSD are at least partially transparent to ambient light.

5. The apparatus of claim 1, wherein the corrected frame is re-sampled by a timewarp module executed by the processor.

6. The apparatus of claim 1, wherein the FSD color channel delay is determined from a time delay between sequentially displayed color channels.

7. The apparatus of claim 1, wherein
the user movements are detected with at least one of: HMD motion sensors or motion sensors at a stationary display, and
the user movement compensation corrects substantially all of the corrected frame.

8. The apparatus of claim 1, wherein the user movements further includes movement between the first FSD and the user.

9. The apparatus of claim 1, wherein the virtual content movement is computed from a motion of a rendered content and the virtual content movement compensation corrects for the motion of the rendered content within the corrected frame.

10. A method for displaying a video to a user, comprising:
rendering an original frame at a processor, wherein the processor is in communication with an eye buffer, wherein the eye buffer is configured to store a frame of the video;
calculating a user movement compensation based on a field-sequential display (“FSD”) color channel delay and user movements based on a difference in a user position determined between a prior frame and the original frame;
calculating a virtual content movement compensation based on the FSD color channel delay and virtual content movements, the virtual content movements based on a first difference in virtual content position of a first block and a second difference in virtual content position of a second block, the first and second differences determined between the prior frame and the original frame:
re-sampling the original frame into a corrected frame based on the user movement compensation and the virtual content movement compensation; and
communicating the corrected frame to the eye buffer for communication to a first FSD configured to sequentially display a plurality of color channels to the user for display.

11. (canceled)

12. The method of claim 10, further comprising:
communicating a second corrected frame to a second FSD configured to sequentially display the plurality of color channels, wherein the first and second FSDs are configured to display a 3D video to the user.

13. The method of claim 12, wherein the first FSD and the second FSD are at least partially transparent to ambient light.

14. The method of claim 10, wherein the corrected frame is re-sampled by a timewarp module executed by the processor.

15. The method of claim 10, wherein the FSD color channel delay is determined from a time delay between sequentially displayed color channels.

16. The method of claim 10, wherein
the user movements are detected with at least one of: HMD motion sensors or motion sensors at a stationary display, and
the user movement compensation corrects substantially all of the corrected frame.

17. The method of claim 10, wherein the user movements further includes movement between the first FSD and the user.

18. The method of claim 10, wherein the virtual content movement is computed from a motion of a rendered content and the virtual content movement compensation corrects for the motion of the rendered content within the corrected frame.

19. A apparatus for displaying a video to a user, comprising:
a first means for sequentially displaying a plurality of color channels;
means for storing a frame of the video, the storage means being in communication with the first displaying means; and
means for processing in communication with the storage means, the processing means configured to,
render an original frame,
calculate a user movement compensation based on a FSD color channel delay and user movements based on a difference in a user position determined between a prior frame and the original frame,
calculate a virtual content movement compensation based on the FSD color channel delay and virtual content movements, the virtual content movements based on a first difference in virtual content position of a first block and a second difference in virtual content position of a second block, the first and second differences determined between the prior frame and the original frame,
re-sample the original frame into a corrected frame based on the user movement compensation and the virtual content movement compensation, and
communicate the corrected frame to the storage means for display on the first displaying means to the user.

20. (canceled)

21. The apparatus of claim 19, further comprising:
a second means for sequentially displaying the plurality of color channels, wherein the first and second displaying means are configured to display a 3D video to the user.

22. The apparatus of claim 21, wherein the first displaying means and the second displaying means are at least partially transparent to ambient light.

23. The apparatus of claim 19, wherein the corrected frame is re-sampled by a timewarp module executed by the processor means.

24. The apparatus of claim 19, wherein the FSD color channel delay is determined from a time delay between sequentially displayed color channels.

25. The apparatus of claim 19, wherein
the user movements are detected with at least one of: HMD motion sensors or motion sensors at a stationary display, and
the user movement compensation corrects substantially all of the corrected frame.

26. The apparatus of claim 19, wherein the user movements further includes movement between the first displaying means and the user.

27. The apparatus of claim 19, wherein the virtual content movement is computed from a motion of a rendered content and the virtual content movement compensation corrects for the motion of the rendered content within the corrected frame.

28. A non-transitory computer-readable storage medium having stored thereon instructions that, when executed, cause a processor to execute a method for displaying a video to a user, the method comprising:
rendering an original frame at a processor, wherein the processor is in communication with an eye buffer, wherein the eye buffer is configured to store a frame of the video;
calculating a user movement compensation based on a field-sequential display (“FSD”) color channel delay and user movements based on a difference in a user position determined between a prior frame and the original frame;
re-sampling the original frame into a corrected frame based on the user movement compensation;
communicating the corrected frame to the eye buffer for communication to a first FSD configured to sequentially display a plurality of color channels to the user for display;
calculating a virtual content movement compensation based on the FSD color channel delay and virtual content movements based on a first difference in virtual content position of a first block and a second difference in virtual content position of a second block determined between the prior frame and the original frame;
further re-sampling the original frame into the corrected frame based on the virtual content movement compensation; and
communicating a second corrected frame to a second FSD configured to sequentially display the plurality of color channels, wherein the first and second FSDs are configured to display a 3D video to the user.

29. The non-transitory computer-readable storage medium of claim 28, wherein
the corrected frame is re-sampled by a timewarp module executed by the processor,
wherein the FSD color channel delay is determined from a time delay between sequentially displayed color channels,
the user movements are detected with at least one of: HMD motion sensors or motion sensors at a stationary display,
the user movement compensation corrects substantially all of the corrected frame,
the user movements further includes movement between the first FSD and the user, and
the virtual content movement is computed from a motion of a rendered content and the virtual content movement compensation corrects for the motion of the rendered content within the corrected frame.

30. The non-transitory computer-readable storage medium of claim 28, wherein the first FSD and the second FSD are at least partially transparent to ambient light.
